(19) United States
(12) Patent Application Publication
(10) Pub. No.: US 2009/0302122 A1
(43) Pub. Date: Dec. 10, 2009

(54) METHOD FOR RECORDING DATA IN A HOLOGRAPHIC FORM ON A LENS AND A CORRESPONDING LENS

(75) Inventor: Cedric Begon, Charenton-Le-Pont (FR)

Correspondence Address: OCCHIUTI ROHLICEK & TSAO, LLP, 10 FAWCETT STREET, CAMBRIDGE, MA, 02138, US

(73) Assignee: Essilor International (Compagnie Generale D'Optique)

(21) Appl. No.: 11/721,237

(22) PCT Filed: Dec. 6, 2005
(86) PCT No.: PCT/FR2005/003053

§ 371 Date: Jun. 22, 2009

(30) Foreign Application Priority Data
Dec. 10, 2004 (FR) 0413185

(51) Int. Cl. G06K 19/00; G03H 1/08; G02C 7/02; B29D 11/00; G06K 19/06

(52) U.S. Cl. 235/494; 359/9; 351/177; 264/2.7; 235/487

(57) ABSTRACT

The inventive method for recording data on an optical lens (2) consists in recording a data-containing source image, in generating the hologram (3) of the image source and in recording said hologram on the lens surface portion ranging from 0.5 mm² to 15 mm². The data can be read-out by illuminating said lens by means of a light beam (101) in the hologram area. A read-out image (105, 106) which reproduces the source image and on which data is readable is formed at a distance from the lens. Said lens can be embodied, in particular in the form of an ophthalmic lens.

The present invention relates to a method of writing data onto an optical lens and to an optical lens comprising data written onto it.

The production of holograms on an optical lens is known for decorative usage. Documents U.S. Pat. No. 5,892,600 and DE 19 644 620 A1 describe for example an optical lens having on its surface a hologram reconstructable in near field, providing a decorative function, which decorative function is combined with an identification role in the case of DE 19 644 620 A1. Document WO 01/23921 A1 discloses an optical lens having on its surface a set of holograms reconstructable in far field, providing a decorative function.

Within the context of the present invention, the purpose of writing the hologram onto the lens is to record relevant data for its production or its use, without modifying its use as an optical lens.

It is difficult to write data onto an optical lens without impeding its use. This is because a lens is transparent and data written onto one of its faces could produce shadows when a light beam passes through the lens. To reduce such an impediment, it is possible to write the data in small characters, or even microscopic characters. It is then necessary to use a magnifying instrument, such as a magnifying glass, to read the characters. Such an instrument is not convenient to use, in particular because the characters cannot be read by several users at the same time.

Now, it is becoming increasingly necessary to indicate on a lens various items of information such as, for example, a manufacturing or serial number, an optical characteristic of the lens, an indication of the constituent material of the lens, an indication of the provenance or distribution channel, or even a price or a code relating to these various characteristics.

Furthermore, in the ophthalmic field, it is now frequent to produce customized corrective lenses, especially according to the ametropia of the person wearing the spectacles. A correction to the wearer's sight is thus obtained, this being more finely tailored to the diagnosed ametropia. In this case, the amount of data that it is useful to write onto the corrective lens may be substantial. Furthermore, the way in which the data is written onto the lens must be compatible with the requirement for medical confidentiality.

An object of the invention is therefore to propose a method for writing data onto a lens that does not have the abovementioned drawbacks.

To this end, the invention provides a method of writing data onto an optical lens, which comprises the following steps:
a) recording a source image containing the data;
b) generating a hologram of said source image by calculation; and
c) writing the hologram onto the lens.

The hologram thus written onto the lens defines a diffractive zone which is generally unsuitable for vision as it affects the transmission of spatial frequencies of the electromagnetic wave, and therefore the capability of that portion of the lens in question to act as an imaging device. For this reason, within the context of the invention, the area of the written hologram is between 0.5 and 15 mm², preferably less than 5 mm². This size range is limited so as to minimize the impediment to the user of the lens, and especially to allow the hologram to be preferentially positioned away from the central region of the lens.

The term “optical lens” is understood in particular to mean ophthalmic lenses and lenses for optical instruments. The term “ophthalmic lens” is understood to mean lenses to be fitted into the frame of the spectacle or visor type, for protecting the eyes and/or for correcting sight, these lenses being chosen from afocal, unifocal, bifocal, trifocal and progressive lenses. Such lenses may be transparent or colored. The term “colored lens” is understood to mean a lens having a level of transmission between 3% and 90% inclusive. Beyond 90%, a lens is considered to be a transparent lens. Within the context of the invention, ophthalmic lenses are preferably understood to mean those described above for being fitted into a spectacles frame.

Given that, according to the invention, the data are written onto the lens in the form of a hologram, they cannot be read directly. The confidentiality requirement is thus met.

Furthermore, the hologram can be read by directing at least one coherent light beam onto the lens or through the lens, at the location of the hologram. Such an operation for reading a hologram is well known. It is simple and the data appear in a read-out image that reconstructs the source image of the hologram. The read-out image is projected onto a screen at a certain distance from the lens, so that it is large enough for several people to be able to read the data at the same time.

Advantageously, the hologram is designed to form the read-out image of the data when said hologram is illuminated by a laser. To read the data, it therefore suffices to use a small laser, of the diode laser pen type for example, of a standard model, which is inexpensive and not bulky.

Advantageously, an optical device may be added to the diode laser in order to project the read-out image onto an image sensor, such as for example a CCD or CMOS matrix. Since the sensor is connected to a computer, such a configuration allows the read-out image to be rapidly read and the data that it contains can be automatically extracted.

The writing method may be used for all types of data, especially corresponding to identification of the lens and to technical, logistic, commercial, medical or marketing information.

More precisely, but not limitingly, the data contained in the hologram may relate to the particulars of the wearer, the particulars of the prescriber, the particulars of the vendor, all the technical data useful for calculating the optical surfaces of the lens and all the data relating to the manufacture of the lens, such as for example the nature of materials used to manufacture the lens and the dates of manufacture. The data contained in the hologram may also relate to all the characteristics of the frame that can receive the lens and all the data useful for cutting or trimming the lens and for fitting it into a frame. Also possibly contained in the hologram are data relating to the lens wearing conditions, such as for example the distance between eye and lens, and also data relating to the conditions of use of the lens, such as for example a preferential use. In addition, commercial data may also be contained in the hologram, such as for example the dates of prescription and purchase of the lens, and the desirable date of replacement of the lens.

The density of the data that can be contained in the hologram may be particularly high, without it being more difficult to read the data by illuminating the hologram. In particular, a hologram measuring 1 square millimeter (1 mm²) in area may contain several kilobytes written redundantly in order to obtain sufficient surety of data reconstruction. The hologram may therefore be written onto the lens by occupying a very small surface portion of the lens. Within the context of the invention, the hologram occupies a portion of the surface of the lens with an area between 15 mm² and 0.5 mm² inclusive, preferably less than 5 mm².

Preferably, the hologram is written onto the lens near a peripheral edge of the latter. In this way, the impediment caused by the hologram during use of the lens is reduced. When the lens is a blank, such as for example the blank of an ophthalmic lens, the hologram may be written in a part of the lens intended to be trimmed off. The blank is then marked right up to the moment of trimming it, for example for the purpose of traceability or logistics, but it causes no impediment when the lens is being used.

According to another particular embodiment of the invention, the data contained in the source image are in coded form. In particular, the source image may contain a barcode corresponding to the data. An additional degree of confidentiality may thus be introduced in order to gain access to the data written on the lens, especially using an algorithm for coding or representing the data in the source image that is kept secret.

The invention also relates to an optical lens, especially an ophthalmic lens, comprising data written in the form of a hologram.

Such a lens may be produced using a method as described above, in order to write data of various types onto it.

Other features and advantages of the present invention will become apparent in the description below of nonlimiting exemplary embodiments, with reference to the appended drawings in which:

FIG. 1 is a diagram of the steps of a method of writing data according to the invention;

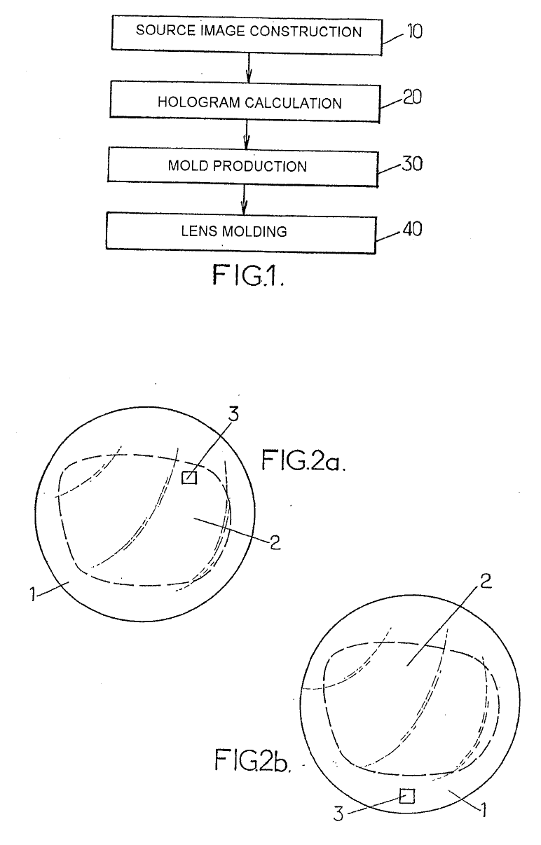

FIGS. 2a and 2b each show an ophthalmic lens blank on which data are written in accordance with the invention;

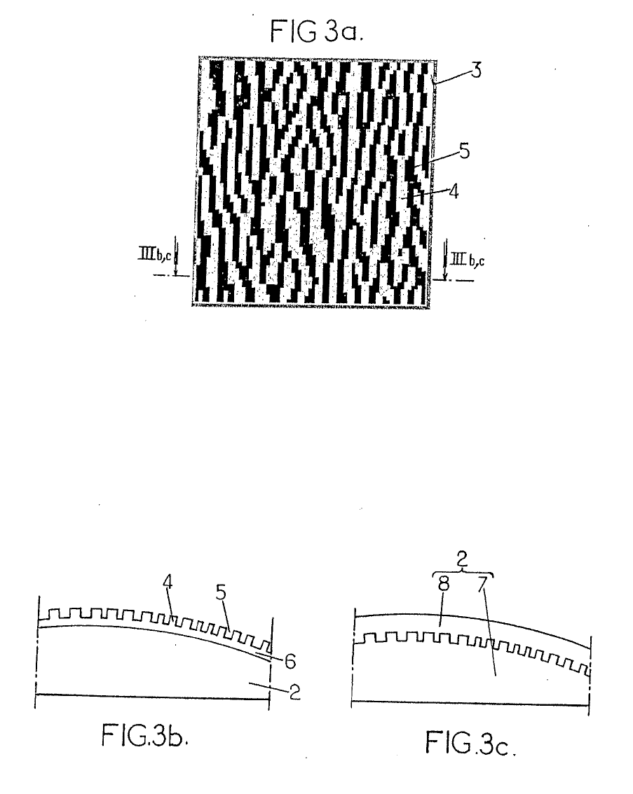

FIGS. 3a-3c are enlargements of a hologram written onto a lens according to the invention;

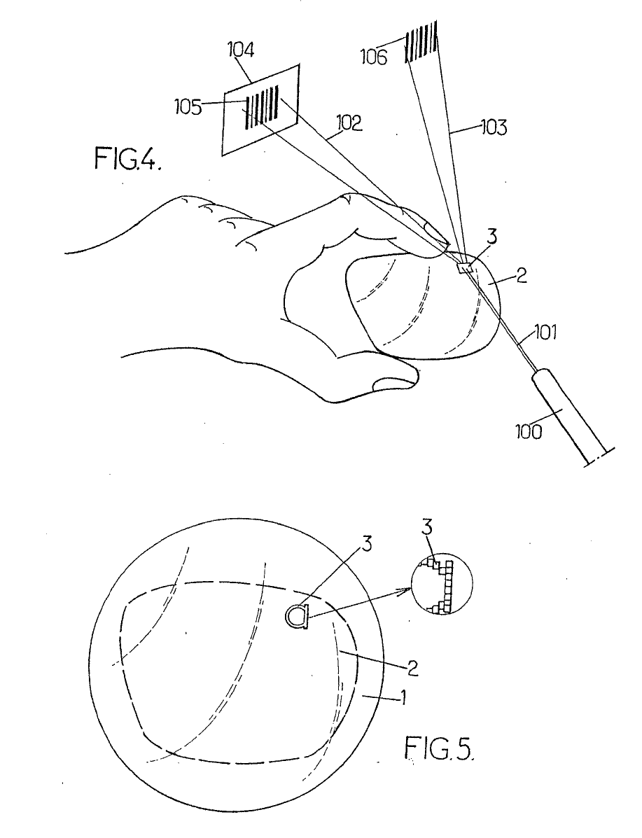

FIG. 4 illustrates the step of reading out the written data according to the invention; and

FIG. 5 shows a lens bearing written data in an improvement of the invention.

For the sake of clarity of the figures, the dimensions of the elements shown are not in proportion with actual dimensions. Furthermore, identical references in different figures denote identical elements or elements that have identical functions.

According to FIG. 1, the method of writing data onto an optical lens starts with the construction of a source image containing the data (step 10). A very wide variety of methods for generating the image may be used, such as photography, the scanning of a printed sheet, etc. Preferably, the source image is generated by calculation, for example using a computer. The image is recorded in the form of a table of light values assigned to pixels of the source image. No physical medium of the source image, such as a sheet of paper or a display table, is therefore necessary. The data contained in the source image may be juxtaposed alphanumeric characters, a barcode corresponding to the data intended to be read, or any other means of visually representing data.

A hologram of the source image is then calculated by the computer (step 20). Various programs are currently available for generating a hologram from a source image. The function of these programs is mainly to carry out a Fourier transform on the source image. The hologram obtained, in the form of a matrix of values, is usually called a computer-generated hologram. The nature of the hologram obtained, namely an amplitude hologram or a phase hologram, and also the pixel density in the hologram and the number of possible levels of the amplitude or phase assigned to each pixel in the hologram depend on the program used and/or its parameter set-up. In particular, binary holograms may be calculated in this way, for which the amplitude assigned to each pixel can take only two values. These two amplitude values are 0 and 1 for a binary amplitude hologram and −1 and +1 for a binary phase hologram.

When calculating the hologram by a computer, it is possible to take into account the curvature of the surface onto which the hologram will be written, in order to minimize any distortion of the read-out image when reconstructing the image under laser illumination. Likewise, if the hologram is written onto a lens the optical power of the lens at the location where the hologram is written can be taken into account, so as to meet certain desirable read-out image reconstruction conditions.

The hologram is then written onto the lens. This writing operation may be carried out in various ways, especially by laser etching. In this case, a laser beam scans juxtaposed regions of a surface portion of the lens with an irradiation power that corresponds to the pixel amplitude values of the hologram. Depending on the irradiation power for each pixel, the laser pulverizes part of the material on the surface of the lens or does not pulverize it. In this way, the hologram is written onto the lens in the form of ridges and grooves. Alternatively, the lens portion may be covered with a metal film, which is removed at the locations of the pixels of the hologram being written through the impacts of the laser, in accordance with the amplitude value associated with each pixel.

Preferably, a pattern corresponding to the hologram is firstly written onto a mold (step 30). For a binary hologram, the amplitude values that may be associated with each pixel of the hologram correspond to two different heights of the surface of the mold, these being separated for example by 1 μm.

According to a first method of implementing the invention, writing the hologram onto the lens comprises the following substeps:
producing a mold transparent to UV radiation and patterned with ridges and grooves corresponding to the hologram;
covering the lens with a layer of a UV-curable fluid;
applying the mold onto to the layer (step 40) so that the fluid penetrates the grooves between the ridges and, at the same time, directing a UV light beam onto the layer through the mold, so as to cure the molded fluid; and
removing the mold from the lens.

Such a writing method is well known and commonly referred to as “UV embossing” or “UV molding”. A suitable material for the mold is, for example, a siloxane-type elastomer such as that one sold by Dow Corning under the brand name Sylgard® 184.

Furthermore, an elastomer mold is particularly suitable for writing a pattern onto a pseudo-spherical surface.

According to a second method of implementing the invention, writing the hologram onto the lens comprises the following substeps:
producing a mold patterned with ridges and grooves corresponding to the hologram;
covering the lens with a layer of a thermally curable fluid;
applying the mold onto the layer (step 40) so that the fluid penetrates the grooves between the ridges and, at the same time, the layer is exposed to a heat source through the mold, so as to cure the molded fluid; and
removing the mold from the lens.

Within the context of the invention, the term “pseudo-spherical surface” is understood to mean a continuous, concave or convex, surface, that is to say one not containing holes or steps. In general, at least one of the two faces of an optical lens is pseudo-spherical so that the variation in thickness of the lens that results therefrom gives it an optical power. Afocal, unifocal, bifocal, trifocal or progressive ophthalmic lenses all have at least one pseudo-spherical face. A spherical surface corresponds to one particular case of a pseudo-spherical surface, for which the radii of curvature of the surface along two perpendicular directions are equal. Hereafter, the expression “pseudo-spherical surface” is understood as including the particular case of spherical surfaces.

To write the hologram onto a pseudo-spherical lens surface, the layer of curable fluid is placed on this surface so as to entirely cover the place for writing the hologram. The mold must be pliant enough to deform so as to conform to the pseudo-spherical surface of the lens when it is applied to the layer of curable fluid.

One drawback of this method of implementation is due to the fact that the hologram written onto the lens is directly exposed to dirt. It may also be damaged by the surface of the lens being accidentally scratched. Data read-out can then be difficult, given that dirt or scratches on the hologram generate interference in the read-out image.

According to a second method of implementing the invention, writing the hologram onto the lens comprises the following substeps:
producing a mold patterned with ridges and grooves corresponding to the hologram (step 30); and
pouring a first refringent lens material (step 40) into the mold.

In this case, the hologram-patterned mold is used directly to form the lens. It must therefore be made of a rigid material. Usually, the first refringent material of the lens is an organic material, for example based on polycarbonate or polyethylene.

A part of the lens bearing the hologram is then coated with a second refringent material, said first and second refringent materials having different respective refractive indices. The second refringent material may also be an organic material. The hologram is therefore written into the lens at the interface between the two refringent materials. It therefore can no longer be degraded by the lens being accidentally scratched. Furthermore, for such a configuration of the lens, the legibility of the data in the read-out image is barely affected by the dirtiness of the lens.

FIGS. 2a and 2b each show an ophthalmic lens blank 1. As is known, the ophthalmic lens 2 is obtained by trimming the blank 1. The trimming outline is indicated by the dashed lines in the figures. The hologram 3 may be written onto the blank either on the inside of the trimming outline (FIG. 2a) or on the outside of the outline (FIG. 2b). The writing on the outside of the trimming outline is appropriate when the written data is no longer of any interest after the lens has been fitted into a frame. This may be the case, for example, for logistic or commercial data. Conversely, it may be advantageous to write medical data on the inside of the trimming outline, so that they remain permanently on the lens. For example, a lens conformity check with respect to a medical prescription may thus be effected on an assembled pair of spectacles.

FIG. 3a shows part of a binary hologram written onto the ophthalmic lens 2. The hologram consists of a matrix of 400×400 approximately square pixels, each pixel having for example sides of 1 μm. The hologram thus measures 0.4 mm×0.4 mm, which is small enough not to generate an appreciable impediment for the person wearing the lens. Visually, the hologram 3 appears as a small diffusing square, which is whitish or has a slightly reflecting appearance. Given that, in this case, each pixel corresponds to a defined level of the lens surface between two possible levels, the hologram appears as a juxtaposition of ridges and grooves, denoted 4 and 5 respectively. According to the general principles of holograms, a potentially vertical arrangement of the ridges 4 and grooves 5 in FIG. 3a indicates that the source image has a structure that is more accentuated in the horizontal direction than in the vertical direction. In the present case, the data contained in the source image are in the form of a horizontally oriented barcode.

FIGS. 3b and 3c are cross sections of the lens 2 at the location of the hologram 3 for each of the first and second methods of writing the hologram 3 described above. FIG. 3b corresponds to the UV-embossing writing method and FIG. 3c corresponds to the hologram being written at the interface between two constituent refringent materials of the lens. In FIG. 3b, the reference 6 denotes the layer of cured fluid and in FIG. 3c the references 7 and 8 denote the respective first and second refringent materials of which the lens 2 is made.

FIG. 4 illustrates the data-readout step. The ophthalmic lens 2 is illuminated with a low-power laser pen 100, possibly including a collimation lens, the beam emitted being for example red in color, at the location of the hologram 3. As is known, the distance between the laser 100 and the hologram 3 is of no importance. The light beam 101 output by the laser 100 is diffracted by the hologram 3 so that it is divided into two secondary beams 102 and 103 after having passed through the lens 2. Each of the two beams 102 and 103 reconstructs the source image at a distance from the lens 2 that may for example be between 20 cm and 50 cm. The reconstructed source image is then revealed by placing an object 104 serving as screen in the path of one of the two beams 102 or 103. Owing to the fact that the light used is output by a laser, the object serving as screen for revealing the reconstructed source image may be any object. The reconstructed source image is square or rectangular in shape, with sides measuring several centimeters. It is therefore easily legible by several people at the same time. It can also advantageously be projected onto an image sensor, for example of the CCD or CMOS type, in order to allow rapid recognition of the image and also analysis of the image using a computer to extract the data that it contains. In FIG. 4, the reconstructed images corresponding to each of the two beams 102 and 103 are referenced 105 and 106 respectively. They are called read-out images and each represents the barcode initially contained in the source image. The images 105 and 106 may correspond to two opposed orders of diffraction, for example +1 and −1, so that the two images 105 and 106 are reversed one with respect to the other. As is known, when the hologram 3 is of the phase hologram type, it is possible to adapt each pixel so that one of the two read-out images produced by diffraction of the beam 101 by the hologram 3 is brighter than the other.

In an improvement of the invention, the hologram is written at several locations on the lens. Given that the cross section of the light beam 101 produced by the laser 100 is of the order of 1 mm², several written holograms may be illuminated simultaneously. Each written hologram therefore contributes to the read-out image(s) so that it (they) is (are) brighter in a manner substantially proportional to the number of written holograms illuminated simultaneously. Advantageously, some of the multiple written holograms 3 on the lens are mutually contiguous. The contrast of the read-out image(s) is therefore improved. Optionally, each written hologram 3 may constitute a pixel of an image directly legible on the lens. FIG. 5 and its enlarged detail illustrate such an improvement. In the example here, all the written holograms 3 on the surface of the ophthalmic blank 1 together form the letter “a” of millimeter size.

A method of writing data according to the invention therefore has many advantages, among which the following may be mentioned or recalled:
the method is compatible with the requirement for an optical lens to be transparent;
the method is compatible with the esthetic requirements specific to ophthalmic use;
the hologram pattern written onto the lens may be easily calculated using standard computing means;
several alternative methods may be used to write the hologram onto the lens, these being easy to implement;
the data written onto the lens can be read in a simple, rapid and inexpensive manner;
no contact with the faces of the lens is needed to read the written data, so that the risk of scratching the lens when reading the data is reduced;
the method is compatible with the requirement for confidentiality of the written data, since they cannot be read directly on the lens;
the amount of data that can be written onto any one lens may be considerable, without this resulting in a noticeable impediment when the lens is being used; and
the data written onto the lens may replace data written on a package for the lens. Switching of respective packages of several lenses is therefore of no consequence—it can be readily detected and, if necessary, corrected.

Finally, the hologram may be written onto the lens in such a way that the read-out image corresponds to the source image positively or negatively depending on whether a light pixel in the source image is reconstructed in the read-out image in the form of a light pixel or a dark pixel.

1. A method of writing data onto an optical lens, comprising the following steps:
a) recording a source image containing the data;
b) generating a hologram of said source image by calculation; and
c) writing the hologram onto the lens, said hologram occupying a surface portion of the lens with an area between 15 mm² and 0.5 mm² inclusive.

2. The method as claimed in claim 1, in which the lens is an ophthalmic lens.

3. The method as claimed in claim 1, in which the data correspond to an identification of the lens, or to technical, logistic, commercial, medical or marketing information.

4. The method as claimed in claim 1, in which the hologram is written close to a peripheral edge of the lens.

5. The method as claimed in claim 4, in which the hologram is written in a part of the lens that is intended to be trimmed off.

6. The method as claimed in claim 1, in which the hologram is a binary hologram.

7. The method as claimed in claim 1, in which the hologram is written at several locations on the lens.

8. The method as claimed in claim 7, in which each written hologram constitutes a pixel of an image directly readable on the lens.

9. The method as claimed in claim 1, in which the data contained in the source image are in coded form.

10. The method as claimed in claim 9, in which the source image contains a barcode corresponding to the data.

11. The method as claimed in claim 1, in which step c) comprises the following substeps:
producing a mold transparent to UV radiation and patterned with ridges and grooves corresponding to the hologram;
covering the lens with a layer of a UV-curable fluid;
applying the mold onto the layer so that the fluid penetrates the grooves between the ridges and, at the same time, directing a UV light beam onto the layer through the mold, so as to cure the molded fluid; and
removing the mold from the lens.

12. The method as claimed in claim 1, in which step c) comprises the following substeps:
producing a mold patterned with ridges and grooves corresponding to the hologram;
covering the lens with a layer of a thermally curable fluid;
applying the mold onto the layer so that the fluid penetrates the grooves between the ridges and, at the same time, exposing the layer to a heat source through the mold, so as to cure the molded fluid; and
removing the mold from the lens.

13. The method as claimed in claim 11, in which the layer of curable fluid is placed on a pseudo-spherical surface of the lens and in which the mold is pliant enough to deform so as to conform to the surface of the lens upon application of said mold to the layer of curable fluid.

14. The method as claimed in claim 1, in which step c) comprises the following substeps:
producing a mold patterned with ridges and grooves corresponding to the hologram; and
pouring a first refringent lens material is poured into the mold.

15. The method as claimed in claim 14, in which a part of the lens bearing the hologram is then coated with a second refringent material, said first and second refringent materials having different respective refractive indices.

16. An optical lens that includes data written in the form of a hologram, said hologram occupying a portion of the surface of the lens with an area between 15 mm² and 0.5 mm² inclusive.

17. The lens as claimed in claim 16, designed for use as an ophthalmic lens.

18. The lens as claimed in claim 16, in which the hologram is designed to form a read-out image containing the data when said hologram is illuminated by a laser.

19. The lens as claimed in claim 16, in which the data correspond to an identification of the lens, or to technical, logistic, commercial, medical or marketing information.

20. The lens as claimed in claim 16, in which the hologram is written close to a peripheral edge of the lens.

21. The lens as claimed in claim 20, in which the hologram is written in a part of the lens that is intended to be trimmed off.

22. The lens as claimed in claim 16, in which the hologram is a binary hologram.

23. The lens as claimed in claim 16, in which the hologram is written at several locations on the lens.

24. The lens as claimed in claim 23, in which each written hologram constitutes a pixel of an image directly readable on the lens.

25. The lens as claimed in claim 16, in which the hologram is designed to form an image containing the data in coded form when said hologram is illuminated.

26. The lens as claimed in claim 25, in which the hologram is designed to form an image of a barcode corresponding to the data when said hologram is illuminated.
